(19) United States
(12) Patent Application Publication
(10) Pub. No.: US 2021/0009188 A1
(43) Pub. Date: Jan. 14, 2021

(54) POWER STEERING SYSTEM WITH A RETRACTABLE STEERING COLUMN ACCORDING TO AN IMPROVED RECOIL TRAVEL BY MEANS OF A LOWER TARGET, FOR AN ANGLE MEASURING DEVICE, INTEGRATED INTO A TANGENT WHEEL OF THE REDUCER

(71) Applicant: JTEKT EUROPE, Irigny (FR)

(72) Inventors: Boris CATHERIN, Decines (FR); Roch MONNET, Brindas (FR); Philippe VERCOUSTRE, Saint Genis Les Ollieres (FR); Laurent REY, Villeurbanne (FR); Raphaël VADON, Lyon (FR); Philippe CHAUVRAT, Villeneuve (FR)

(73) Assignee: JTEKT EUROPE, Irigny (FR)

(21) Appl. No.: 16/927,374

(22) Filed: Jul. 13, 2020

(30) Foreign Application Priority Data
Jul. 12, 2019 (FR) 19/07848

(51) Int. Cl. B62D 1/185; B62D 5/04; B62D 3/04; B62D 15/02

(52) U.S. Cl. CPC B62D 1/185; B62D 15/022; B62D 3/04; B62D 5/0463

(57) ABSTRACT

A power steering system for a motor vehicle, including a steering column integrating an upper shaft and an intermediate shaft connected in rotation and relatively movable in translation, an upper tube and a lower tube connected in rotation and relatively movable in translation, the upper shaft being movable in rotation and connected in translation in the upper tube, and an assist module integrating an output shaft connected in rotation to the intermediate shaft via a torsion bar, a reducer including a worm screw driven by an assist motor and which meshes on a tangent wheel connected to the output shaft; and an angle measuring device including an inductive sensor, a lower target mounted secured to the output shaft and an upper target secured to an upper lateral face of a core made of a plastic material of the tangent wheel.

The invention relates to a power steering system for a motor vehicle.

It relates more particularly to a power steering system comprising a retractable steering column in the case of an accident to provide a function of absorbing energy by retraction.

In terms of safety and during a frontal impact of the vehicle, such a retraction in fact provides an axial displacement of the steering wheel with a level of effort or absorption to limit or avoid damage for the driver. This axial displacement of the steering wheel takes place over a certain recoil travel (also called a crash stroke) which corresponds to the retraction length of the steering column which supports the steering wheel.

Conventionally, such a steering system comprises a steering column integrating:
an upper shaft and an intermediate shaft coaxial along a main axis, connected in rotation and movable in translation axially relative to one another; and
an upper tube and a lower tube coaxial along the main axis, connected in rotation and movable in translation axially relative to one another, where the upper shaft is mounted movable in rotation inside the upper tube, and is connected in translation axially to the upper tube.

This conventional steering system further comprises an assist module integrating a reducing casing on which the lower tube is fixed and integrating, at least partially housed inside the reducing casing:
an output shaft connected in rotation to the intermediate shaft by means of a torsion bar;
a reducer comprising a worm screw driven by an assist motor and which meshes on a tangent wheel connected in rotation to the output shaft;
an angle measuring device suitable for measuring a torsion angle between the output shaft and the intermediate shaft, said angle measuring device comprising an inductive sensor and two targets disposed on either side of the inductive sensor along the main axis, said targets comprising an upper target mounted secured all about the intermediate shaft and a lower target mounted secured all about the output shaft.

During an accident, the driver chest impacts the steering wheel carried at an upper end of the upper shaft. Thus, the steering wheel impacted by the driver chest drives the upper shaft in a recoil movement along the main axis. This upper shaft is connected by a sliding connection to the intermediate shaft which is fixed to it, and this upper shaft is connected to the upper tube allowing it to be guided in rotation. Also, during the accident, the upper tube will also be driven in a recoil movement along the main axis and will slide relative to the lower tube itself fixed. Thus, the upper shaft and the upper tube will be driven along the main axis securely up to a mechanical stop so that the stroke traveled to this mechanical stop constitutes the recoil travel.

Conventionally, the mechanical stop which limits the stroke of the upper tube is located on the lower tube, either on the inner periphery of the lower tube in the case where the upper tube is inside the lower tube, or on the outer periphery of the lower tube in case where the upper tube is outside the lower tube is either internal or external to the lower tube.

The recoil stroke is therefore ensured by a telescopic movement of the steering column. Conventionally, the initial length of the steering system, measured along the main axis, is characterized by the distance along the main axis between the upper end of the upper shaft (hereinafter point V1) and the lower end of the output shaft (hereinafter point V2). During an accident, the point V1 approaches the point V2, the upper shaft recoiling (as explained above) and the point V2 being fixed (the output shaft being mounted fixed in translation in the reducing casing and coupled to the steering rack). Thus, the point V1 approaches the point V2 by a length which corresponds to the recoil stroke. The different elements of the steering column which succeed one another between the point V1 and the point V2 allow a more or less significant recoil stroke.

From the point V2 there is the reducer which has an incompressible length, then the angle measuring device which also has an incompressible length, then finally up to the point V1 the assembly consisting of the intermediate shaft connected to the upper shaft and by the lower tube connected to the upper tube, where the upper shaft and the intermediate shaft are movable in translation axially relative to one another and likewise the upper tube and the lower tube are movable in translation axially relative to one another.

Thus, only one portion of the steering column is sliding or telescopic to carry out the recoil stroke. However, the upper shaft and the intermediate shaft, and likewise the upper tube and the lower tube, do not slide over all of their respective lengths in order to ensure a certain rigidity in the steering column. The overlap lengths between the upper shaft and the intermediate shaft, and between the upper tube and the lower tube, depend on their respective diameters, but are conventionally in the range of 40 to 60 millimeters.

An objective of the invention is to increase the recoil stroke, in order to improve the safety of the driver by increasing the recoil of the steering wheel during an accident which causes the driver to impact the steering wheel.

Another objective of the invention is to propose a technical solution which increases the recoil stroke without harming the functioning of the steering system.

To this end, the invention proposes a power steering system for a motor vehicle, comprising a steering column integrating
an upper shaft and an intermediate shaft coaxial along a main axis, connected in rotation and movable in translation axially relative to one another; and
an upper tube and a lower tube coaxial along the main axis, connected in rotation and movable in translation axially relative to one another, where the upper shaft is mounted movable in rotation inside the upper tube, and is connected in translation axially to the upper tube;

this power steering system further comprising an assist module integrating a reducing casing on which the lower tube is fixed and integrating, at least partially housed inside the reducing casing:
an output shaft connected in rotation to the intermediate shaft by means of a torsion bar;
a reducer comprising a worm screw driven by an assist motor and which meshes on a tangent wheel connected in rotation to the output shaft;
an angle measuring device suitable for measuring a torsion angle between the output shaft and the intermediate shaft, said angle measuring device comprising an inductive sensor and two targets arranged on either side of the inductive sensor along the main axis, said targets comprising an upper target mounted secured about the intermediate shaft and a lower target mounted secured about the output shaft;

this power steering system being remarkable in that the tangent wheel comprises a core made of a plastic material about the output shaft, and in that the lower target is secured to an upper lateral face of said core.

Indeed, an angle measuring device with inductive sensor implements two targets made of electrically conductive material, generally made of a metallic material, which are placed one on the output shaft, the other on the intermediate shaft and which allow the inductive sensor to measure the relative angle between the two targets and therefore between the intermediate shaft and the output shaft. By measuring this angle, it is then possible to calculate the torque exerted by the driver on the steering wheel as the product of the stiffness of the torsion bar and the measured angle. An induced current is created between the targets and the inductive sensor, located between the two targets, allows by a known principle to measure the angle.

However, it is necessary to electrically isolate the targets from any significant metallic mass which could disturb the currents induced between each target and the inductive sensor. Conventionally with a metallic tangent wheel, it is essential to establish a minimum distance (along the main axis) between the lower target (that on the side of the tangent wheel) and the tangent wheel, generally between 5 and 20 millimeters, to prevent the tangent wheel from disturbing the currents induced between the lower target and the inductive sensor.

The invention, by proposing to press the lower target on or to integrate the lower target to the upper lateral face of a plastic core of the tangent wheel, makes it possible to gain on the recoil stroke the aforementioned minimum distance between 5 and 20 millimeters, being noted that this plastic core, necessarily non-electrically conductive, makes it possible not to disturb the currents induced between the lower target and the inductive sensor. It is further indicated that the tangent wheel is secured in rotation to the output shaft so that the lower target turns with the output shaft, and therefore this lower target fulfills its function of marking the rotation of the output shaft as part of the angle measuring device.

The lower target is secured to the upper lateral face of the core by gluing, or by welding (necessarily without the use of metallic material), or by clipping, or by snap-riveting, or by overmolding, or by screwing.

Alternatively, the lower target is secured to the upper lateral face of the core by a metallic deposit on the upper lateral face.

This metallic deposit forming the lower target is for example produced by hot stamping of a metallic film carried by a support film, or by selective metallization of the upper lateral face of the core.

A hot stamping consists in applying on the upper lateral face a metallic film carried by a support film by means of a heating tool comprising in relief the pattern of the lower target, this heating tool being used to apply a pressure on the metallic film placed on the upper lateral face. Upon contact with the temperature of the heating tool and the exerted pressure, the metallic film is transferred to the upper lateral face to form the lower target. The advantages of such a hot stamping are to be of reduced cost and high precision.

A selective metallization consists in affixing a mask on the upper lateral face, and in applying a metallic deposit, generally under vacuum and for example by spraying or projecting, whose contours will be defined by the mask.

According to a variant, the lower target has a thickness comprised between 100 and 300 micrometers.

According to a variant, the lower target is made of a metallic material such as for example aluminum, steel, copper, iron, or a metal alloy.

According to one characteristic, the core comprises a rim made of a plastic material and a toothed crown made of a plastic material molded about the rim, and the lower target is secured to the rim and/or the crown.

The formation of such a core made of a plastic material with rim and toothed crown is known for example from documents EP2952321, EP3155296 and EP3134246, which all concern an overmolding method consisting in overmolding in a first plastic material a rim in the shape of a corolla on the output shaft, then to coat this rim in a second plastic material, forming a crown at the periphery of which are then shaped teeth intended to mesh with the worm screw of the reducer.

The plastic material(s) used for the core are, for example, of the type of polyamide, polybutylene terephthalate or polypropylene reinforced with glass, carbon or aramid fibers or a combination of the three.

In a particular embodiment, the inductive sensor is mounted on a fixed annular support, made of an electrically insulating material and extending inside the reducing casing around the intermediate shaft or the output shaft.

This electrically insulating material is for example a plastic material, such as a reinforced plastic material (polyamide or polybutylene terephthalate or polyphenylene sulphone or other technical thermoplastics or a thermosetting epoxy, polyurethane, . . . reinforced with glass, carbon, aramid fibers or a combination of these fibers).

According to one possibility, the annular support has an outer ring disposed around the inductive sensor and mounted on the reducing casing.

Thus, the annular support is carried by the reducing casing, and this annular support can be blocked in rotation using shapes around the connection cable which connects the inductive sensor to a controller and to a power supply.

According to another possibility, the outer ring of the annular support is mounted directly on the reducing casing, or is mounted on a subplate secured to the lower tube and fixed on the reducing casing, or is mounted on a plate of a fixing sleeve fixed on the reducing casing, said fixing sleeve comprising a socket secured to the plate and on which the lower tube is fixed.

Indeed, this outer ring can be mounted directly on the reducing casing, in a bearing extending about the intermediate shaft or the output shaft, or alternatively this outer ring can be mounted on a subplate of the lower tube which comes into the aforementioned bearing (this subplate of the lower tube being fixed on the reducing casing), or alternatively this outer ring can be mounted on the plate of the fixing sleeve which comes into the aforementioned bearing (the lower tube being fixed on the socket of this fixing sleeve).

According to another possibility, the inductive sensor is overmolded inside the annular support or assembled on the annular support.

In a particular embodiment, the upper tube is mounted about the lower tube or the upper tube is mounted inside the lower tube.

Other characteristics and advantages of the present invention will appear on reading the detailed description below, of non-limiting implementing examples, made with reference to the appended figures in which:

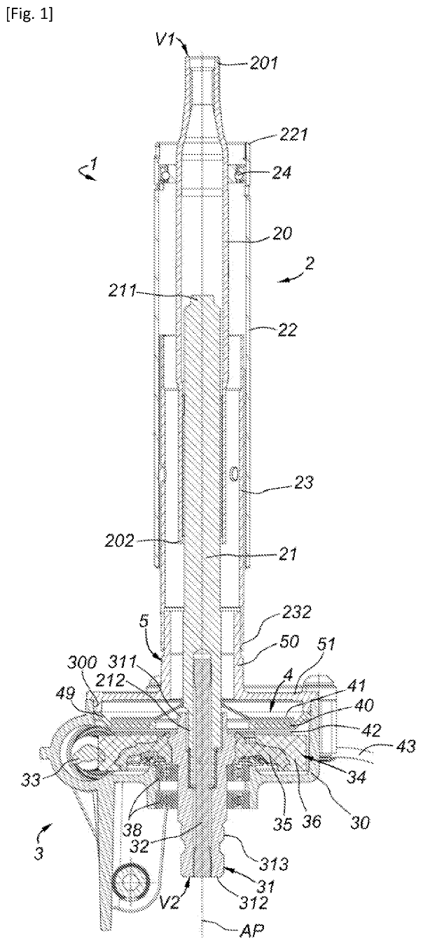

FIG. 1 is a schematic view in axial section of a first steering system according to the invention, where the upper tube is mounted about the lower tube;

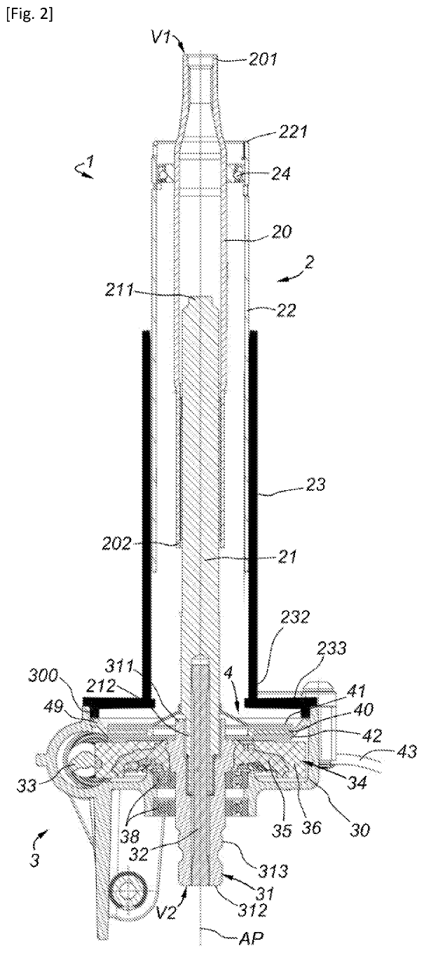

FIG. 2 is a schematic view in axial section of a second steering system according to the invention, where the upper tube is mounted inside the lower tube;

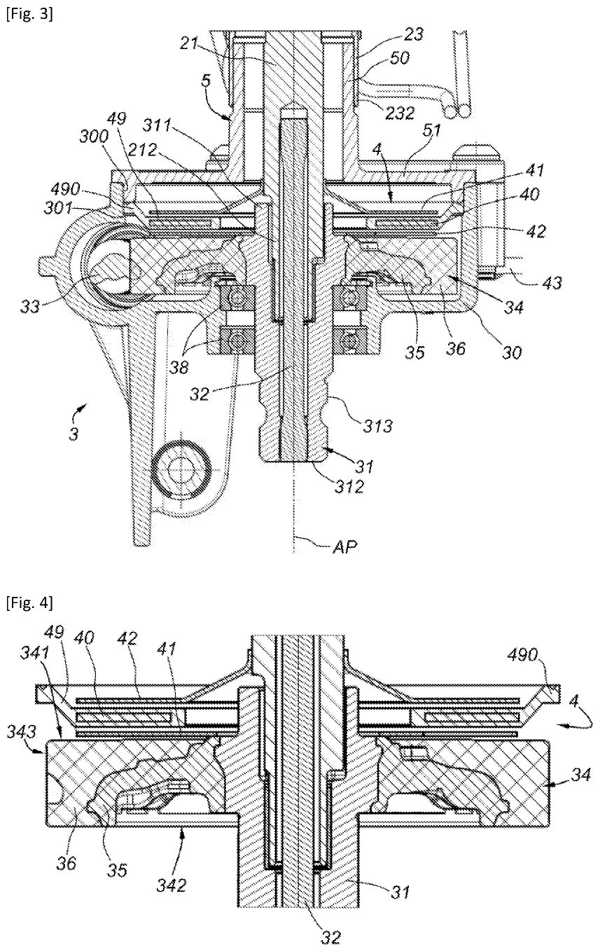

FIG. 3 is a zoomed schematic view on a portion of the first steering system of FIG. 1, centered on the angle measuring device;

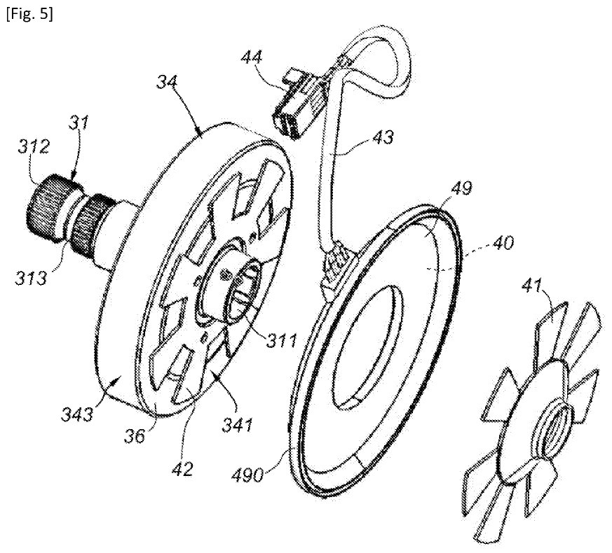

FIG. 4 is a schematic view of the tangent wheel and angle measuring device assembly, mounted about the output shaft and the intermediate shaft, of the first steering system or of the second steering system of FIGS. 1 and 2;

FIG. 5 is a schematic perspective and exploded view of the tangent wheel and angle measuring device assembly, with the tangent wheel integrated by molding on the output shaft.

Referring to FIGS. 1 and 2, a power steering system 1 according to the invention comprises a steering column 2 coupled to an assist module 3.

The steering column 2 is of the telescopic type and it comprises:
an upper shaft 20 and an intermediate shaft 21 coaxial along a main axis AP, where the upper shaft 20 and the intermediate shaft 21 are connected in rotation and are movable in translation axially (along the main axis AP) relative to one another; and
an upper tube 22 and a lower tube 23 coaxial along the main axis AP, where the upper tube 22 and the lower tube 23 are connected in rotation and movable in translation axially (along the main axis AP) relative to one another, and where the upper shaft 20 is mounted movable in rotation inside the upper tube 22 and is connected in translation axially to the upper tube 22.

The upper tube 22 and the upper shaft 20 form the upper portion of the steering column 2, with the upper shaft 20 which has an upper end 201 (forming the point V1 previously mentioned) on which is mounted a steering wheel (not illustrated). A rolling bearing 24 is provided between the upper tube 22 and the upper shaft 20, at an upper end 221 of the upper tube 22, to guide the rotation of the upper shaft 20 inside the upper tube 22.

The lower tube 23 and the intermediate shaft 21 form the bottom portion of the steering column 2, with the lower tube 23 which has a lower end 232 fixed on the assist module 3, and more particularly on a reducing casing 30.

In the embodiment of FIG. 1, the lower tube 23 is secured to a fixing sleeve 5 comprising:
a socket 50 (of a generally cylindrical shape) on which the lower tube 23 is fixed, the lower tube 23 being fitted on this socket 50, and
a plate 51 secured to the socket 50, this plate 51 being fixed on the reducing casing 30, for example by screwing, this plate 51 being engaged in an upper cylindrical bearing 300 of the reducing casing 30 extending about the intermediate shaft 21, and this plate 51 is provided with a central hole through which the intermediate shaft 21 passes.

In the embodiment of FIG. 2, the lower tube 23 has its lower end 232 which is secured to a subplate 233 fixed on the reducing casing 30, for example by screwing, this subplate 233 being engaged in an upper cylindrical bearing 300 of the reducing casing 30 extending about the intermediate shaft 21, and this subplate 233 is provided with a central hole through which the intermediate shaft 21 passes.

The upper shaft 20 has a lower end 202 connected by a sliding connection along the main axis AP to an upper end 211 of the intermediate shaft 21 which is fixed to it. The upper tube 22 is connected by a sliding connection along the main axis AP to the lower tube 23 which is fixed to it, with:
either the upper tube 22 which is mounted about the lower tube 23 as in the example of FIG. 1 (and in this case the upper tube 22 is outer to the lower tube 23),
or the upper tube 22 which is mounted inside the lower tube 23 as in the example of FIG. 2 (and in this case the upper tube 22 is inner to the lower tube 23).

During an accident, the driver chest impacts the steering wheel, driving both the upper shaft 20 in a recoil movement along the main axis AP by sliding on the intermediate shaft 21, and the upper tube 22 in a recoil movement along the main axis AP by sliding on or in the lower tube 23; the upper shaft 20 and the upper tube 22 being driven along the main axis AP securely over a maximum distance corresponding to the recoil stroke.

The assist module 3 comprises the reducing casing 30 on which the lower tube 23 is fixed and this assist module 3 comprises, at least partially housed inside the reducing casing 30:
an output shaft 31 (also called pinion) connected in rotation to the intermediate shaft 21 by means of a torsion bar 32;
a reducer comprising a worm screw 33 driven by an assist motor (not illustrated) and which meshes on a tangent wheel 34 connected in rotation to the output shaft 31;
an angle measuring device 4 suitable for measuring a torsion angle between the output shaft 31 and the intermediate shaft 21.

The output shaft 31 has an upper end 311 connected in rotation to a lower end 212 of the intermediate shaft 21 via the torsion bar 32. The output shaft 31 has a lower end 312 (forming the point V2 previously mentioned) and at which a pinion 313 is provided, engaged with a steering rack (not illustrated); such a steering rack being provided with two ends intended to be coupled to respective tie rods, themselves attached to ball joint housings on the wheel side respectively associated with the right and left steered wheels of the motor vehicle.

Thus, an additional motor torque (or possibly a resistant torque) can be transmitted to the output shaft 31, and therefore to the pinion 313 engaged with the steering rack, this additional torque being added to the torque exerted manually by the driver of the motor vehicle, on the steering wheel connected to the steering column 2.

The output shaft 31 is rotatably mounted about the main axis AP inside the reducing casing 30 by means of at least one rolling bearing 38 carried by the reducing casing 30.

The tangent wheel 34 comprises a core made of a plastic material about the output shaft 31, the tangent wheel 34 then being integrated into the output shaft 31 by overmolding in at least one plastic material of the core on this output shaft 31.

This core made of a plastic material is composed of a rim 35 made of a first plastic material and forming a corolla on and about the output shaft 31, and a toothed crown 36 made of a second plastic material on the periphery of the rim 35; where this crown 36 forms the outer part of the core of the tangent wheel 34 which is in mesh with the worm screw 33.

This core made of a plastic material can be produced according to overmolding methods described for example in documents EP2952321, EP3155296 and EP3134246, to which one skilled in the art will usefully refer for further details.

This core made of a plastic material of the tangent wheel 34 has two lateral faces 341, 342 opposite and joined by an outer periphery 343 in which teeth are formed, these lateral faces 341, 342 comprising:
an upper lateral face 341 turned towards the side of the upper shaft 20 and therefore also of the angle measuring device 4; and
a lower lateral face 342 turned towards the side of the pinion 313.

The angle measuring device 4 is integrally housed inside the reducing casing 30 and it extends about the intermediate shaft 21 or the output shaft 31, at least about a lower portion of the intermediate shaft 21 which is housed inside the reducing casing 30 or about an upper portion of the output shaft 31. The angle measuring device 4 is interposed between the tangent wheel 34 and the lower tube 23, and more precisely between the tangent wheel 34 and the subplate 233 of the lower tube 23 or between the tangent wheel 34 and the plate 51 of the fixing sleeve 5.

This angle measuring device 4 comprises an inductive sensor 40 and two targets 41, 42 disposed on either side of the inductive sensor 40 along the main axis AP. These targets 41, 42 comprise:
an upper target 41 mounted secured about the intermediate shaft 21, so that this upper target 41 is located on the side of the upper shaft 20 with respect to the inductive sensor 40;
a lower target 42 mounted secured about the output shaft 31, so that this upper target 41 is located on the side of the tangent wheel 34 and of the pinion 313 with respect to the inductive sensor 40.

These targets 41, 42 are secured in rotation to the intermediate shaft 21 and to the output shaft 31 respectively, and these targets 41, 42 are made of electrically conductive material, generally made of a metallic material, so that the inductive sensor 40 allows measuring the relative angle between the two targets 41, 42 and therefore between the intermediate shaft 21 and the output shaft 31; an induced current being created between the targets 41, 42 and the inductive sensor 40 to perform an angle measurement.

The inductive sensor 40 is thus connected to a connection cable 43, to connect the inductive sensor 40 to a control unit (for example of the controller or processor type) and to an electric power supply, by means of a suitable connector 44.

These targets 41, 42 can for example be made of steel sheet with a thickness comprised between 0.5 and 5 millimeters. Referring to FIG. 5, these targets 41, 42 are for example in the form of discs provided at the outer periphery with a multitude of toothed sectors.

Thus, this angle measuring device 4 makes it possible to measure the relative angle between the intermediate shaft 21 and the output shaft 31, and this measurement can be injected into a control unit which can calculate the torque exerted by the conductor on the steering wheel as the product of the stiffness of the torsion bar and the measured angle; this torque is then used to drive the assist motor.

According to the invention, the lower target 42 is secured to the upper lateral face 341 of the core made of a plastic material of the tangent wheel 34. This lower target 42 is secured to the rim 35 and/or the crown 36, according to the dimensions of the rim 35 and of the crown 36 on the upper lateral face 341 and according to the dimensions (inner diameter and outer diameter) of the lower target 42.

In the embodiment illustrated in FIGS. 1 to 4, the lower target 42 is secured only to the rim 35, while in a variant not illustrated, the lower target 42 is secured to both the rim 35 and the crown 36, in other words this lower target 42 extends astride on the rim 35 and the crown 36, and in another variant not illustrated, the lower target 42 is only secured to the crown 36.

The lower target 42 can be fixed directly to the tangent wheel 34 by gluing, clipping, welding, snap-riveting, screwing or overmolding or any other method allowing the lower target 42 and the tangent wheel 34 to be securely connected, such as for example hot stamping on the upper lateral face 341 of the core of a metallic film carried by a support film, or a selective metallization of the upper lateral face 341 of the core.

By adopting a tangent wheel 34 with a core made of a plastic material and in particular including a rim 35 and a crown 36 made of a plastic material, the electrical interactions and disturbances between the lower target 42 and the tangent wheel 34 are removed and thus the lower target 42 is fixed on the tangent wheel 34, which makes it possible to remove any distance between the lower target 42 and the tangent wheel 34, which results in a gain for the recoil stroke of the upper shaft 20 and of the upper tube 22 in the event of an accident.

Furthermore, the inductive sensor 40 is mounted on a fixed annular support 49, made of an electrically insulating material (for example plastic) and extending inside the reducing casing 30 about the intermediate shaft 21 or the output shaft 31.

In the illustrated example, the inductive sensor 40 is overmolded inside the annular support 49, and in a variant not illustrated, this inductive sensor 40 is assembled on the annular support 49.

This annular support 49 is traversed by the intermediate shaft 21 or the output shaft 31, and this annular support 49 has an outer ring 490 disposed about the inductive sensor 40 and mounted in the upper bearing 300 of the reducing casing 30.

In the illustrated example, the outer ring 490 is mounted directly in the upper bearing 300 of the reducing casing 30, by fitting, and this outer ring 490 is blocked axially on one side by an inner shoulder 301 (referenced in FIG. 3) formed in the reducing casing 30 following the upper bearing 300, and on the other side by the plate 51 of the fixing sleeve 5 or by the subplate 233.

In a variant not illustrated, the outer ring 490 is mounted on the subplate 233 of the lower tube 23. In another variant not illustrated, the outer ring 490 is mounted on the plate 51 of the fixing sleeve 5.

1. A power steering system for a motor vehicle, comprising a steering column integrating:
an upper shaft and an intermediate shaft coaxial along a main axis, connected in rotation and movable in translation axially relative to one another; and
an upper tube and a lower tube coaxial along the main axis connected in rotation and movable in translation axially relative to one another, where the upper shaft is mounted movable in rotation inside the upper tube and is connected in translation axially to the upper tube;
said power steering system further comprising an assist module integrating a reducing casing on which the lower tube is fixed and integrating, at least partially housed inside the reducing casing:
an output shaft connected in rotation to the intermediate shaft via a torsion bar;
a reducer comprising a worm screw driven by an assist motor and which meshes on a tangent wheel connected in rotation to the output shaft;
an angle measuring device suitable for measuring a torsion angle between the output shaft and the intermediate shaft, said angle measuring device comprising an inductive sensor and two targets disposed on either side of the inductive sensor along the main axis, said targets comprising an upper target mounted secured about the intermediate shaft and a lower target mounted secured about the output shaft;
said power steering system being wherein the tangent wheel comprises a core made of a plastic material about the output shaft, and in that the lower target is secured with an upper lateral face of said core.

2. The power steering system according to claim 1, wherein the lower target is secured to the upper lateral face of the core by gluing.

3. The power steering system according to claim 1, wherein the lower target is secured to the upper lateral face of the core by welding.

4. The power steering system according to claim 1, wherein the lower target is secured to the upper lateral face of the core by clipping.

5. The power steering system according to claim 1, wherein the lower target is secured to the upper lateral face of the core by snap-riveting.

6. The power steering system according to claim 1, wherein the lower target is secured to the upper lateral face of the core by overmolding.

7. The power steering system according to claim 1, wherein the lower target is secured to the upper lateral face of the core by screwing.

8. The power steering system according to claim 1, wherein the lower target is secured to the upper lateral face of the core by a metallic deposit on the upper lateral face.

9. The power steering system according to claim 8, wherein the metallic deposit forming the lower target is produced by hot stamping of a metallic film carried by a support film, or by a selective metallization of the upper lateral face of the core.

10. The power steering system according to claim 1, wherein the core comprises a rim made of a plastic material and a toothed crown made of a plastic material molded about the rim, and the lower target is secured to the rim and/or the crown.

11. The power steering system according to claim 1, wherein the inductive sensor is mounted on a fixed annular support, made of an electrically insulating material and extending inside the reducing casing about the intermediate shaft or the output shaft.

12. The power steering system according to claim 11, wherein the annular support has an outer ring disposed about the inductive sensor and mounted on the reducing casing.

13. The power steering system according to claim 12, wherein the outer ring of the annular support is mounted directly on the reducing casing, or is mounted on a subplate secured to the lower tube and fixed on the reducing casing, or is mounted on a plate of a fixing sleeve fixed on the reducing casing, said fixing sleeve comprising a socket secured to the plate and on which the lower tube is fixed.

14. The power steering system according to claim 11, wherein the inductive sensor is molded inside the annular support or assembled on the annular support.

15. The power steering system according to claim 1, wherein the upper tube is mounted about the lower tube or the upper tube is mounted inside of the lower tube.
